(19) United States
(12) Patent Application Publication
(10) Pub. No.: US 2007/0099610 A1
(43) Pub. Date: May 3, 2007

(54) Method of automatically backing up and restoring PIMS data of mobile communication terminal

(75) Inventors: Hyung Sub Kim, Seongnam-si (KR); Jeong Youl Ha, Seoul (KR)

Correspondence Address: MADSON & AUSTIN;GATEWAY TOWER WEST, SUITE 900, 15 WEST SOUTH TEMPLE, SALT LAKE CITY, UT, 84101, US

(73) Assignees: Daesin Information Technology Co., Ltd.; Mtechware Co., Ltd.

(21) Appl. No.: 11/294,242

(22) Filed: Dec. 5, 2005

(30) Foreign Application Priority Data
Oct. 31, 2005 (KR) 2005-0102714

(51) Int. Cl. H04Q 7/20

(52) U.S. Cl. 455/432.2; 455/433

(57) ABSTRACT

A method of automatically backing up and restoring PIMS data stored in a mobile communication terminal is disclosed which allows the users of mobile communication terminals to conveniently restore previously maintained PIMS data in new mobile communication terminals without any loss of the data even when damage, loss or replacement of the mobile communication terminal occurs. To accomplish the above object, the invention encodes update-related information and user authentication information, transmits them to a PMIS data backup/restoration server while the user is not engaging in wireless communication, and stores them when the PIMS data of a user is updated in a mobile communication terminal.

### BACKGROUND OF THE INVENTION

1. Field of the Invention

The present invention relates generally to a method of automatically backing up and restoring Personal Information Management System (PIMS) data stored in a mobile communication terminal, such as a portable phone, and, more particularly, to a method of transmitting PIMS data to a PIMS data backup/restoration server without the intervention of a user and backing it up when the generation, amendment, or deletion of the PIMS data occurs in a mobile communication terminal, and receiving the backed-up PIMS data from the PIMS data backup/restoration server and restoring the PIMS data in the mobile communication terminal at the request of a user, thereby preventing the loss of the PIMS data due to damage, loss or replacement of the mobile communication terminal when damage, loss or replacement of the mobile communication terminal occurs.

2. Description of the Related Art

Generally, a mobile communication terminal, such as a mobile phone, is equipped with a PIMS, which stores various information, including the telephone numbers of communication parties.

When using a mobile communication terminal, a user frequently amends, deletes or adds PIMS data. For example, there is a need to transfer the PIMS data of a mobile communication terminal to a new mobile communication terminal at the time of replacement of a mobile communication terminal, and a need to periodically back up the PIMS data because the PIMS data is lost when the mobile communication terminal is damaged or lost.

Conventional methods of backing up or restoring backed-up PIMS data in a mobile communication terminal include a method of connecting a mobile communication terminal to a personal computer in a wired manner and using a PIMS data backup and restoration program in the personal computer, and a method of connecting a mobile communication terminal to a website supporting PIMS data backup and restoration via the wireless Internet and backing up and restoring PIMS data.

That is, Korean Unexamined patent Publication No. 2004-65345 entitled “Method of Backing up User's Telephone Numbers stored in Portable Mobile Communication Terminal and Recording Medium Recording Program for Executing the Backup Method” discloses a method of backing up user's telephone numbers stored in the memory of a portable mobile communication terminal using the portable mobile communication terminal having an email transmission function and, which includes steps of connecting the terminal to a mail server hasting an email address used by a terminal user; selecting a menu item corresponding to a function of backing up the user's telephone numbers stored in the memory in the terminal from a menu which is transmitted from the mail server connected to the terminal and displayed; adding the data file of the telephone numbers, which is stored in the memory of the terminal, to a corresponding portion of the selected menu item; and transmitting the menu item, to which the data file is added, to the mail server.

Furthermore, Korean Unexamined patent Publication No. 2004-93341 entitled “System and Method for Storing Personal Information of Mobile Communication Terminal in Server and Downloading It” discloses a system for storing the personal information of a mobile communication terminal in a server, which includes a wireless communication network for transmitting and receiving data to and from the mobile communication terminal via wireless channels; a server for connecting with the wireless communication network, classifying user-related information received from the mobile communication terminal according to mobile communication unit, and storing it; and the Internet for connecting with the wireless communication network via a gateway and transmitting and receiving data to and from a plurality of computer terminals through a wired network. Korean Unexamined patent Publication No. 2004-93341 also discloses a method of storing the personal information existing in a mobile communication terminal in a server in a mobile communication system capable of data communication with a wireless network, which includes the steps of transmitting the user-related information stored in the mobile communication terminal; transmitting the received user-related information to a personal information server and storing it; transmitting a message requesting the download of the user-related information from the wireless communication network to the mobile communication terminal; transmitting the user-related information, stored in the personal information server and matched to the mobile communication terminal, to the mobile communication terminal; requesting the download of the user-related information stored in the personal information server through the computer terminal connected to the Internet; updating the user-related information stored in the personal information server through a computer terminal connected to the Internet; and transmitting the updated user-related information to the mobile communication terminal.

However, in conventional methods including the above-described methods, after a mobile communication terminal has been connected to a personal computer or a management server in response to a user's manipulation, PIMS data is backed up or restored, so that a backup operation is inconvenient and a excessive time is taken to perform a backup.

Furthermore, if PIMS data stored in a mobile communication terminal is not backed up due to a user's carelessness, a problem occurs in that the previous PIMS data is not restored in a new mobile communication terminal when damage, loss or replacement of the mobile communication terminal occurs. Furthermore, there is a problem in that, although a user periodically backs up the PIMS data stored in a mobile communication terminal, PIMS data, which was updated after most recent PIMS data backup operation, cannot be restored.

### SUMMARY OF THE INVENTION

Accordingly, the present invention has been made keeping in mind the above problems occurring in the prior art, and an object of the present invention is to provide a method of automatically backing up and restoring PIMS data stored in a mobile communication terminal, which allows the users of mobile communication terminals to conveniently restore previously maintained PIMS data in new mobile communication terminals without any loss of the data even when damage, loss or replacement of the mobile communication terminal occurs.

In order to accomplish the above object, the present invention encodes update-related information and user authentication information, transmits them to a PMIS data backup/restoration server while the user is not engaging in wireless communication, and stores them when the PIMS data of a user is updated in a mobile communication terminal.

Furthermore, the present invention encodes user authentication information, transmits it to the backup/restoration server, receives the PIMS data of a corresponding user from the backup/restoration server after user authentication, and restores and stores the PIMS data when a user request is made.

Furthermore, the present invention receives and decodes the encoded information of the user, then determines whether the user is an authentic user based on the received authentication information, updates PIMS data of a corresponding user with corresponding data if the user request is a request for backup of PIMS data from an authentic user, and encodes the PIMS data of the corresponding user and transmits it to the corresponding user if the user request is a request for restoration of PIMS data.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a client (mobile communication mobile) and a server in a system for automatically backing up and restoring the PIMS data of a mobile communication terminal according a preferred embodiment of the present invention;

FIG. 2 is a flowchart illustrating a process of automatically backing up and restoring PIMS data in a client according to a preferred embodiment of the present invention;

FIG. 3 is a flowchart illustrating a process of automatically backing up PIMS data in a client according to a preferred embodiment of the present invention;

FIG. 4 is a flowchart illustrating a process of restoring PIMS data in a client according to a preferred embodiment of the present invention; and

FIG. 5 is a flowchart illustrating a process of automatically backing up and restoring PIMS data in a server according to a preferred embodiment of the present invention.

### DESCRIPTION OF THE PREFERRED EMBODIMENTS

Reference now should be made to the drawings, in which the same reference numerals are used throughout the different drawings to designate the same or similar components.

Preferred embodiments of the present invention are described in detail with reference to the accompanying drawings.

FIG. 1 is a diagram showing the construction of a client (mobile communication mobile) and a server in a system for automatically backing up and restoring the PIMS data of a mobile communication terminal according to a preferred embodiment of the present invention.

The mobile communication mobile of a user includes an automatic PIMS data backup/restoration processor 100, a PIMS data backup/restoration protocol encoder/decoder 101 and a PIMS data transmission/reception unit 102. A backup/restoration server of a service provider includes a PIMS data transmission/reception unit 110, a PIMS data backup/restoration protocol encoder/decoder 111, an automatic PIMS data backup/restoration processor 112 and a PIMS data storage unit l 13.

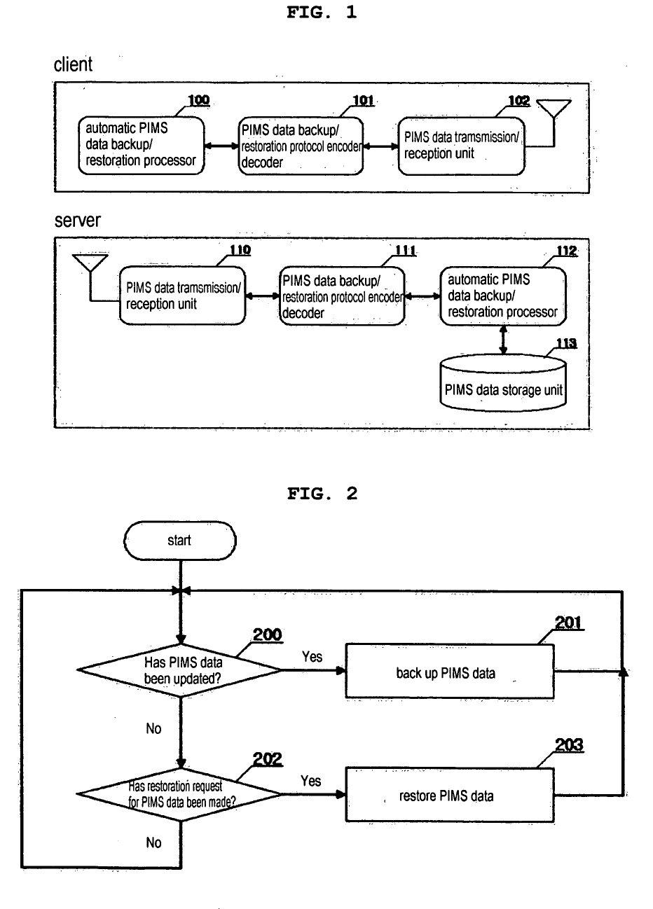

FIG. 2 is a flowchart illustrating a process of automatically backing up and restoring PIMS data in a user according to a preferred embodiment of the present invention. The process of automatically backing up and restoring PIMS data in a user, that is, a mobile communication terminal, includes step 200 of determining whether the PIMS data of the user has been updated, step 201 of automatically backing up the PIMS data if the PIMS data of the user has been updated, step 202 of determining whether a restoration request for the PIMS data has been made, and step 203 of restoring the PIMS data when the restoration request has been made.

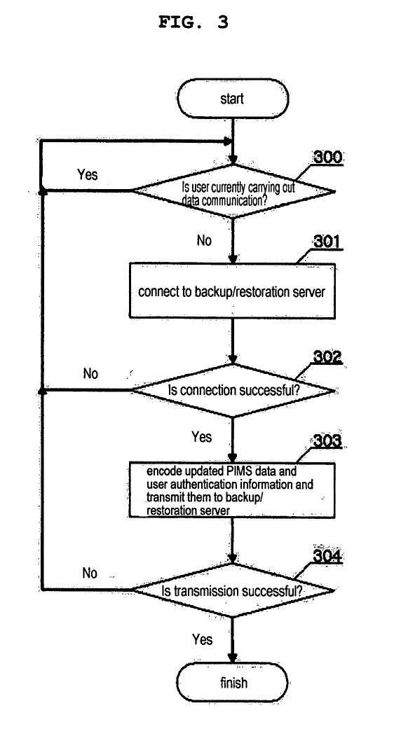

FIG. 3 is a flowchart illustrating a process of automatically backing up PIMS data in a user according to a preferred embodiment of the present invention. The process of automatically backing up the PIMS data in a user, that is, a mobile communication terminal, includes step 300 of determining whether the user is currently carrying out data communication, step 301 of connecting the mobile communication terminal to the backup/restoration server when the user is not carrying out data communication, step 302 of determining whether the connection is successful; step 303 of encoding the updated PIMS data and user authentication information and transmitting them to the backup/restoration server if the connection is successful, and step 304 of determining whether the transmission is successful.

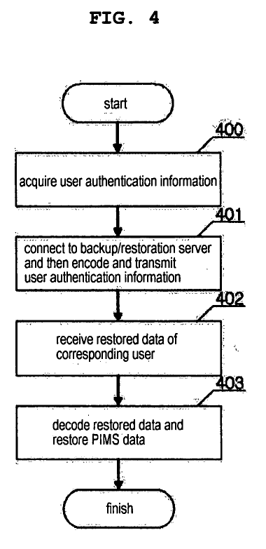

FIG. 4 is a flowchart illustrating a process of restoring PIMS data in a user according to a preferred embodiment of the present invention. The process of restoring PIMS data in a user includes step 400 of acquiring user authentication information, step 401 of connecting to the backup/restoration server and then encoding and transmitting the user authentication information, step 402 of receiving the restored data of a corresponding user, and step 403 of decoding the restored data and restoring PIMS data.

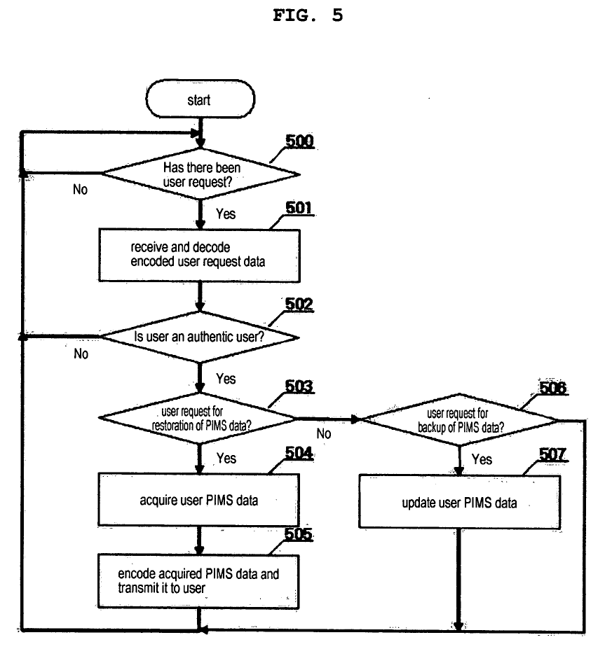

FIG. 5 is a flowchart illustrating a process of automatically backing up and restoring PIMS data in a server according to a preferred embodiment of the present invention. The process of automatically backing up and restoring PIMS data in the backup/restoration server of a service provider, includes step 500 of determining whether there has been a user request for the backup or restoration of PIMS data, step 501 of receiving an encoded user request data and decoding it if a user request exists, step 502 of determining whether the user is an authentic user, step 503 of determining whether the user request is a request for the restoration of PIMS data when it is determined that the user is an authentic user, step 504 of acquiring user PIMS data from a database if the user request is a request for restoration of PIMS data, step 505 of encoding the acquired PIMS data and transmitting it to the user, step 506 of determining whether the user request is a request for the backup of PIMS data, and step 507 of updating user PIMS data when the user request is a request for the backup of PIMS data

In the present invention, the service provider provides wired/wireless Internet service for socket communication, an appropriate charging method based on data characteristics, and a stable communication network for service, so that wireless Internet service is activated through a new service model.

As described above, the present invention automatically transmits the changed content of a user's PIMS data to a PIMS backup/restoration server while the user does not use the mobile communication terminal, and storing the transmitted PIMS data in the PIMS backup/restoration server after user authentication, using the PIMS backup/restoration server, so that the latest PIMS data of the user is automatically backed up, thereby preventing the loss of the user's PIMS data at the time of damage, loss or replacement of the mobile communication terminal.

Furthermore, in accordance with the present invention, a user transmits user authentication information to a PIMS data backup/restoration server at the time of damage, loss or replacement of the mobile communication terminal, and requests previously backed-up user's PIMS data. The PIMS data backup/restoration server authenticates the user based on the transmitted authentication information and then transmits the backed-up user's PIMS data to the mobile communication terminal of the user that requested the backup. Thereafter, the mobile communication terminal restores the PIMS data, thereby restoring the PIMS data that was used in the mobile communication terminal at the time of incidental damage, loss or replacement of the mobile communication terminal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of automatically backing up and restoring Personal Information Management System (PIMS) data of a mobile communication terminal, comprising the steps of:
providing a mobile communication terminal comprising an automatic PIMS data backup/restoration processor, a PIMS data backup/restoration protocol encoder/decoder, and a PIMS data transmission/reception unit, and a backup/restoration server of a service provider, comprising a PIMS data transmission/reception unit, a PIMS data backup/restoration protocol encoder/decoder, an automatic PIMS data backup/restoration processor and a PIMS data storage unit;
when user PIMS data is updated in the mobile communication terminal, encoding update-related data and user authentication information, transmitting them to the backup/restoration server while the user is not engaging in wireless communication, thereby storing them in the backup/restoration server; and
when a user request is made, encoding user authentication information, transmitting it to the backup/restoration server, receiving PIMS data of a corresponding user from the backup/restoration server after user authentication, and restoring and storing the PIMS data in the mobile communication terminal.

2. The method as set forth in claim 1, further comprising the steps of receiving and decoding the encoded information of the user, then determining whether the user is an authentic user based on the received authentication information, updating PIMS data of a corresponding user with corresponding data if the user request is a request for backup of PIMS data from a rightful user, and encoding PIMS data of the corresponding user and transmitting it to the corresponding user if the user request is a request for restoration of PIMS data from a rightful user.

3. The method as set forth in claim 1, wherein the backup and restoration of the PIMS data in the mobile communication terminal of a user comprises the steps of determining whether the PIMS data of the user has been updated; automatically backing up the PIMS data if the PIMS data of the user has been updated; determining whether a restoration request for the PIMS data has been made; and restoring the PIMS data when the restoration request has been made.

4. The method as set forth in claim 1, wherein the backup of the PIMS data in the mobile communication terminal of a user comprises the steps of determining whether the user is currently carrying out data communication; connecting the mobile communication terminal to the backup/restoration server when the user is not carring out data communication; determining whether the connection is successful; encoding the updated PIMS data and user authentication information and transmitting them to the backup/restoration server if the connection is successful; and determining whether the transmission is successful.

5. The method as set forth in claim 1, wherein the restoration of the PIMS data in the mobile communication terminal of a user comprises the steps of acquiring user authentication information; connecting the mobile communication terminal to the backup/restoration server and then encoding and transmitting the user authentication information; receiving the restored data of the user; and decoding the restored data and restoring PIMS data.

6. The method as set forth in claim 1, wherein the backup and restoration of the PIMS data in the backup/restoration server of a service provider comprises the steps of determining whether there has been a user request for backup or restoration of PIMS data; receiving encoded user request data and decoding it if there has been the user request; determining whether the user is an authentic user; determining whether the user request is a request for restoration of PIMS data if the user is an authentic user; acquiring user PIMS data from a database if the user request is a request for restoration of PIMS data; encoding the acquired PIMS data and transmitting it to the user; determining whether the user request is a request for backup of PIMS data; and updating user PIMS data if the user request is a request for backup of PIMS data.
